(19) United States
(12) Patent Application Publication
(10) Pub. No.: US 2026/0111455 A1
(43) Pub. Date: Apr. 23, 2026

(54) SYSTEM

(71) Applicant: SoftBank Group Corp., Tokyo (JP)

(72) Inventor: Yusuke NISHIJIMA, Tokyo (JP)

(21) Appl. No.: 19/354,307

(22) Filed: Oct. 9, 2025

(30) Foreign Application Priority Data
Oct. 18, 2024 (JP) 2024-184015

(51) Int. Cl. G06F 16/332; G06F 16/335

(52) U.S. Cl. CPC G06F 16/3326; G06F 16/337

(57) ABSTRACT

The system according to the embodiment includes a collection unit, an analysis unit, a generation unit, and a request unit. The collection unit collects data such as alarm information, technical specifications, and past response histories. The analysis unit analyzes the data collected by the collection unit. The generation unit generates a response method based on the result analyzed by the analysis unit. The request unit makes a request based on the response method generated by the generation unit.

### CROSS-REFERENCE TO RELATED APPLICATION

The present application claims priority to and incorporates by reference the entire contents of Japanese Patent Application No. 2024-184015 filed in Japan on October 18, 2024.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that manual intervention is required in maintenance response operations for base stations, resulting in low efficiency.

### SUMMARY OF THE INVENTION

The system according to the embodiment includes a collection unit, an analysis unit, a generation unit, and a request unit. The collection unit collects data such as alarm information, technical specifications, and past response histories. The analysis unit analyzes the data collected by the collection unit. The generation unit generates a response method based on the result analyzed by the analysis unit. The request unit makes a request based on the response method generated by the generation unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as "processor") may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, "A and/or B" means "at least one of A and B." In other words, "A and/or B" means it may be only A, only B, or a combination of A and B. Moreover, when expressing three or more items connected by "and/or," the same concept as "A and/or B" applies.

### First Embodiment

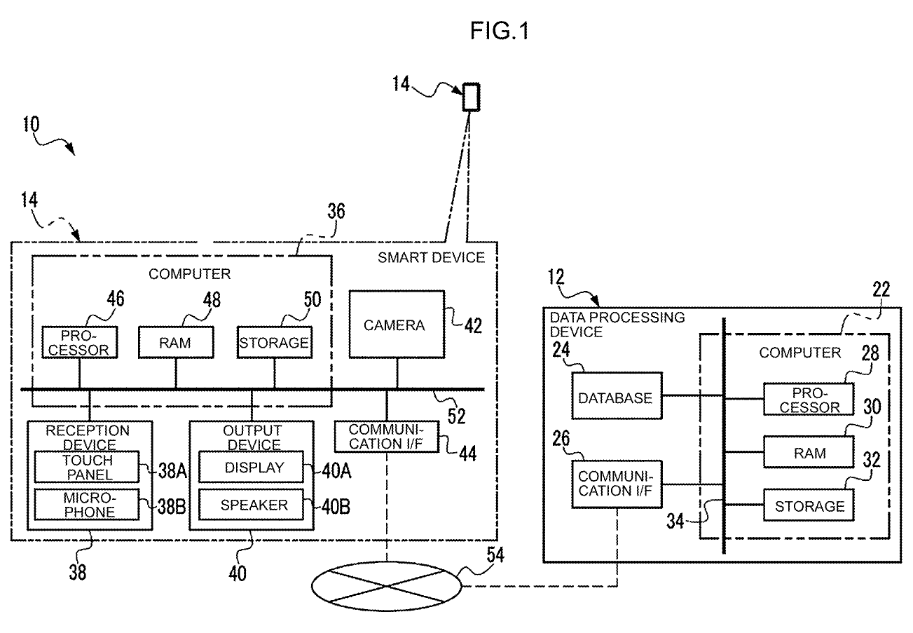

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

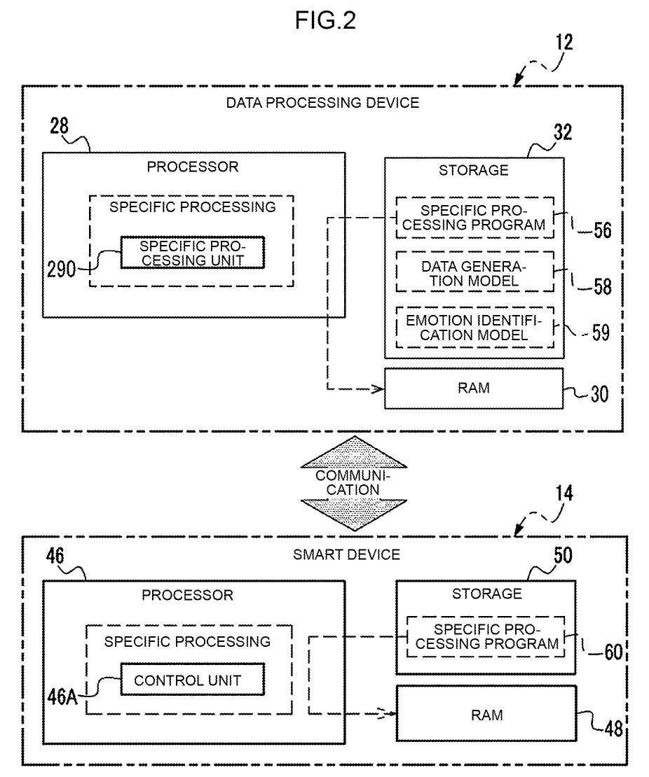

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a "program" related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The maintenance response system according to the embodiment of the present invention is a system that substitutes maintenance response operations for base stations using generative AI. Currently, in the maintenance response system, a person considers a response method based on alarm information, technical specifications, and past response histories, and makes a request to an external contractor, but by replacing these operations with generative AI, the man-hours for base station maintenance operations can be greatly reduced and failure responses that are impossible for humans can be realized. For example, the maintenance response system collects data such as alarm information, technical specifications, and past response histories. Next, the maintenance response system analyzes these data using generative AI and generates an optimal response method. Based on the generated response method, the maintenance response system makes a request to an external contractor. With this mechanism, the efficiency of base station maintenance operations is improved and failure responses that are impossible for humans become possible. For example, when an alarm occurs at a base station, the maintenance response system analyzes the alarm information using generative AI, refers to past response histories and technical specifications, and generates an optimal response method. Based on the generated response method, the maintenance response system makes a request to an external contractor and can respond quickly. With this system, not only can the man-hours for base station maintenance operations be greatly reduced, but also failure responses that are impossible for humans can be realized. For example, even if a complex failure occurs, the maintenance response system can quickly generate an optimal response method using generative AI and respond accordingly. As a result, stable operation of the base station is ensured and service quality can be expected to improve. Thus, the maintenance response system can greatly reduce the man-hours for base station maintenance operations and realize failure responses that are impossible for humans.

The maintenance response system according to the embodiment includes a collection unit, an analysis unit, a generation unit, and a request unit. The collection unit collects data such as alarm information, technical specifications, and past response histories. The collection unit can, for example, collect alarm information in real time. The collection unit can also collect technical specifications in digital format. Furthermore, the collection unit can acquire past response histories from a database. For example, the collection unit directly acquires alarm information from sensors and stores it in a database in real time. Technical specifications are collected in PDF or text format and stored in the database. Past response histories are acquired from the database using queries and provided to the analysis unit. The analysis unit analyzes the data collected by the collection unit. The analysis unit can, for example, analyze the data using generative AI and generate an optimal response method. The analysis unit can also analyze data patterns using data mining techniques. The analysis unit can also analyze data trends using statistical analysis techniques. For example, the analysis unit inputs alarm information, technical specifications, and past response histories into generative AI and generates an optimal response method. Data mining techniques extract useful patterns from the data and help generate response methods. Statistical analysis techniques analyze data trends and improve the accuracy of response methods. The generation unit generates a response method based on the result analyzed by the analysis unit. The generation unit can, for example, generate a response method using generative AI. The generation unit can also generate a response method based on manuals and guidelines. The generation unit can also generate a response method with reference to past response histories. For example, the generation unit inputs the analysis result into generative AI and generates an optimal response method. Manuals and guidelines are referenced in the generation of response methods. Past response histories provide response methods for similar failures. The request unit makes a request based on the response method generated by the generation unit. The request unit can, for example, make a request to an external contractor. The request unit can also automatically generate a request form and send it to the external contractor. The request unit can also check the request content and modify it as necessary. For example, the request unit automatically generates a request form based on the generated response method and sends it to the external contractor. The request form describes the details of the response method and provides specific instructions to the external contractor. The request content is checked by the request unit and modified as necessary. Thus, the maintenance response system according to the embodiment can greatly reduce the man-hours for base station maintenance operations and realize failure responses that are impossible for humans.

The collection unit collects data such as alarm information, technical specifications, and past response histories. Specifically, alarm information is acquired in real time from sensors and immediately stored in a database. This allows the system to always maintain the latest alarm information and enables prompt response. Technical specifications are digitized in PDF or text format and stored in the database. This allows engineers to quickly search for and refer to necessary information. Past response histories are acquired from the database using queries and provided to the analysis unit. This enables analysis based on past response histories and is expected to generate more accurate response methods. The collection unit centrally manages these data and can cooperate with other systems or departments as necessary. For example, the collected data are stored on a cloud server so that the analysis unit and generation unit can access them. In addition, by adjusting the frequency and accuracy of data collection, flexible responses can be made according to specific situations or conditions. This allows the collection unit to efficiently and effectively collect data and improve the overall performance of the system. Furthermore, the collection unit introduces a verification process to ensure the consistency and reliability of the data and maintains data quality. For example, by using algorithms that detect and automatically correct data duplication or missing data, the accuracy of the data can be improved. As a result, the collection unit can provide highly reliable data and improve the reliability of the entire system.

The analysis unit analyzes the data collected by the collection unit. The analysis unit can, for example, analyze the data using generative AI and generate an optimal response method. Specifically, alarm information, technical specifications, and past response histories are input into generative AI to generate an optimal response method. The generative AI uses natural language processing technology to analyze technical specifications and past response histories and proposes response methods based on alarm information. Data mining technology extracts useful patterns from the data and helps generate response methods. For example, common patterns are found from past response histories to identify optimal response methods for similar failures. Statistical analysis technology analyzes data trends and improves the accuracy of response methods. For example, the frequency of alarm information and the content of technical specifications are used to predict the possibility of specific failures and take countermeasures in advance. Furthermore, the analysis unit can utilize past data and statistical information to perform long-term risk assessment and trend analysis. For example, based on past failure data, the analysis unit predicts risk fluctuations in specific regions or time periods and plans future countermeasures. In addition, the analysis unit can use anomaly detection algorithms to detect unusual patterns or abnormal data and issue early warnings. This enables the analysis unit to not only grasp real-time situations but also handle long-term risk management and anomaly detection, thereby improving the reliability and safety of the entire system.

The generation unit generates a response method based on the result analyzed by the analysis unit. The generation unit can, for example, generate a response method using generative AI. Specifically, the analysis result is input into generative AI to generate an optimal response method. The generative AI refers to past response histories and technical specifications to propose optimal response procedures. Manuals and guidelines are referenced in the generation of response methods. For example, standard response procedures for specific failures can be used as a basis to customize specific response methods. Past response histories provide response methods for similar failures. For example, when a similar failure occurred in the past, the response method at that time can be referenced to generate an optimal response procedure. The generation unit integrates this information and can quickly generate an optimal response method. Furthermore, the generation unit can evaluate the accuracy and effectiveness of the generated response method and make corrections as necessary. For example, the generated response method can be simulated to check whether it fits the actual situation. The generation unit can also collect feedback from users and use it to improve response methods. This allows the generation unit to always provide highly accurate response methods based on the latest information and support prompt and appropriate responses. Furthermore, the generation unit can automatically document the generated response method and share it with other departments or systems. This ensures consistency and transparency of response methods and improves the efficiency of the entire system.

The request unit makes a request based on the response method generated by the generation unit. Specifically, a request is made to an external contractor. The request unit can also automatically generate a request form and send it to the external contractor. For example, the request unit automatically generates a request form based on the generated response method and sends it to the external contractor. The request form describes the details of the response method and provides specific instructions to the external contractor. The request content is checked by the request unit and modified as necessary. For example, the content of the request form is checked and corrected if there are errors or unclear points. The request unit can also monitor the progress of the request and follow up as necessary. For example, the request unit receives reports from the external contractor and checks the progress of the response. In addition, the request unit records the request content and progress in a database and uses it as a reference for the future. This allows the request unit to make requests efficiently and effectively and improve the reliability and efficiency of the entire system. Furthermore, the request unit can share the request content and progress with other departments or systems to strengthen overall cooperation. For example, the request unit notifies other departments of the request content and requests necessary support. The request unit can also evaluate the result of the request and use it for future improvement. This allows the request unit to always make optimal responses and improve the performance of the entire system.

The collection unit can collect data such as alarm information, technical specifications, and past response histories. The collection unit can, for example, collect alarm information in real time. The collection unit can also collect technical specifications in digital format. The collection unit can also acquire past response histories from a database. For example, the collection unit directly acquires alarm information from sensors and stores it in a database in real time. Technical specifications are collected in PDF or text format and stored in the database. Past response histories are acquired from the database using queries and provided to the analysis unit. This enables efficient collection of necessary data.

The analysis unit can analyze the collected data and generate an optimal response method. The analysis unit can, for example, analyze the data using generative AI and generate an optimal response method. The analysis unit can also analyze data patterns using data mining techniques. The analysis unit can also analyze data trends using statistical analysis techniques. For example, the analysis unit inputs alarm information, technical specifications, and past response histories into generative AI and generates an optimal response method. Data mining techniques extract useful patterns from the data and help generate response methods. Statistical analysis techniques analyze data trends and improve the accuracy of response methods. This enables the analysis of collected data and the generation of optimal response methods.

The generation unit can make a request to an external contractor based on the generated response method. The generation unit can, for example, generate a response method using generative AI. The generation unit can also generate a response method based on manuals and guidelines. The generation unit can also generate a response method with reference to past response histories. For example, the generation unit inputs the analysis result into generative AI and generates an optimal response method. Manuals and guidelines are referenced in the generation of response methods. Past response histories provide response methods for similar failures. This enables the generation unit to make a request to an external contractor based on the generated response method.

The request unit can make a request based on the generated response method. The request unit can, for example, make a request to an external contractor. The request unit can also automatically generate a request form and send it to the external contractor. The request unit can also check the request content and modify it as necessary. For example, the request unit automatically generates a request form based on the generated response method and sends it to the external contractor. The request form describes the details of the response method and provides specific instructions to the external contractor. The request content is checked by the request unit and modified as necessary. This enables the request unit to make a request based on the generated response method.

The collection unit can analyze past data collection histories and select an optimal collection method. The collection unit can, for example, identify the most efficient collection method from past data collection histories and apply it to future data collection. The collection unit can also select the optimal collection method for specific time periods or conditions based on past data collection histories. The collection unit can analyze past data collection histories, identify points for improvement in collection methods, and optimize them. For example, the collection unit acquires past data collection histories from a database and analyzes them using data mining techniques. The collection unit selects data collection methods for specific time periods or conditions and achieves efficient data collection. The collection unit identifies points for improvement in collection methods and optimizes them to improve the accuracy and efficiency of data collection. This enables the collection unit to analyze past data collection histories and select an optimal collection method.

The collection unit can perform filtering based on the current operational status and environmental conditions of a base station during data collection. The collection unit can, for example, monitor the operational status of the base station in real time and collect data only when an abnormality occurs. The collection unit can also prioritize data collection under specific conditions by considering environmental conditions (such as weather and temperature). The collection unit can also adjust the type and amount of data to be collected based on the operational status and environmental conditions of the base station. For example, the collection unit monitors the operational status of the base station in real time and collects data only when an abnormality occurs. The collection unit prioritizes data collection under specific conditions by considering environmental conditions (such as weather and temperature). The collection unit adjusts the type and amount of data to be collected based on the operational status and environmental conditions of the base station. This enables the collection unit to filter data collection based on the operational status and environmental conditions of the base station.

The collection unit can preferentially collect highly relevant data by considering the geographical location information of the base station during data collection. The collection unit can, for example, preferentially collect environmental data in the vicinity based on the geographical location information of the base station. The collection unit can also prioritize data collection in specific regions by considering the geographical location information of the base station. The collection unit can also filter and collect highly relevant data based on the geographical location information of the base station. For example, the collection unit preferentially collects environmental data in the vicinity based on the geographical location information of the base station. The collection unit prioritizes data collection in specific regions by considering the geographical location information of the base station. The collection unit filters and collects highly relevant data based on the geographical location information of the base station. This enables the collection unit to preferentially collect highly relevant data by considering the geographical location information of the base station.

The collection unit can analyze the social media activities of the base station during data collection and collect relevant data. The collection unit can, for example, monitor the social media activities of the base station and collect relevant data. The collection unit can also analyze trends on social media and preferentially collect data related to the base station. The collection unit can also collect data related to the base station based on user feedback on social media. For example, the collection unit monitors the social media activities of the base station and collects relevant data. The collection unit analyzes trends on social media and preferentially collects data related to the base station. The collection unit collects data related to the base station based on user feedback on social media. This enables the collection unit to analyze the social media activities of the base station and collect relevant data.

The analysis unit can adjust the level of detail of analysis based on the importance of the data during analysis. The analysis unit can, for example, perform detailed analysis for highly important data. The analysis unit can also perform simplified analysis for less important data. The analysis unit can also determine the priority of analysis according to the importance of the data. For example, the analysis unit evaluates the importance of the data and performs detailed analysis for highly important data. The analysis unit performs simplified analysis for less important data. The analysis unit determines the priority of analysis according to the importance of the data. This enables the analysis unit to adjust the level of detail of analysis based on the importance of the data.

The analysis unit can apply different analysis algorithms according to the category of data during analysis. The analysis unit can, for example, apply a specific analysis algorithm to data based on technical specifications. The analysis unit can also apply a different analysis algorithm to data based on alarm information. The analysis unit can also apply yet another analysis algorithm to data based on past response histories. For example, the analysis unit applies a specific analysis algorithm to data based on technical specifications. The analysis unit applies a different analysis algorithm to data based on alarm information. The analysis unit applies yet another analysis algorithm to data based on past response histories. This enables the analysis unit to apply different analysis algorithms according to the category of data.

The analysis unit can determine the priority of analysis based on the data collection timing during analysis. The analysis unit can, for example, preferentially analyze the latest data. The analysis unit can also preferentially analyze data from specific periods based on past data. The analysis unit can also adjust the order of analysis according to the data collection timing. For example, the analysis unit preferentially analyzes the latest data. The analysis unit preferentially analyzes data from specific periods based on past data. The analysis unit adjusts the order of analysis according to the data collection timing. This enables the analysis unit to determine the priority of analysis based on the data collection timing.

The analysis unit can adjust the order of analysis based on the relevance of the data during analysis. The analysis unit can, for example, preferentially analyze highly relevant data. The analysis unit can also postpone the analysis of less relevant data. The analysis unit can also dynamically adjust the order of analysis according to the relevance of the data. For example, the analysis unit preferentially analyzes highly relevant data. The analysis unit postpones the analysis of less relevant data. The analysis unit dynamically adjusts the order of analysis according to the relevance of the data. This enables the analysis unit to adjust the order of analysis based on the relevance of the data.

The generation unit can adjust the level of detail of generation based on the importance of the data when generating the response method. The generation unit can, for example, generate response methods based on highly important data in detail. The generation unit can also generate response methods based on less important data in a simplified manner. The generation unit can also determine the priority of response methods to be generated according to the importance of the data. For example, the generation unit generates response methods based on highly important data in detail. The generation unit generates response methods based on less important data in a simplified manner. The generation unit determines the priority of response methods to be generated according to the importance of the data. This enables the generation unit to adjust the level of detail of generation based on the importance of the data.

The generation unit can apply different generation algorithms according to the category of data when generating the response method. The generation unit can, for example, apply a specific generation algorithm to response methods based on technical specifications. The generation unit can also apply a different generation algorithm to response methods based on alarm information. The generation unit can also apply yet another generation algorithm to response methods based on past response histories. For example, the generation unit applies a specific generation algorithm to response methods based on technical specifications. The generation unit applies a different generation algorithm to response methods based on alarm information. The generation unit applies yet another generation algorithm to response methods based on past response histories. This enables the generation unit to apply different generation algorithms according to the category of data.

The generation unit can determine the priority of generation based on the data collection timing when generating the response method. The generation unit can, for example, preferentially generate response methods based on the latest data. The generation unit can also postpone the generation of response methods based on past data. The generation unit can also adjust the order of response methods to be generated according to the data collection timing. For example, the generation unit preferentially generates response methods based on the latest data. The generation unit postpones the generation of response methods based on past data. The generation unit adjusts the order of response methods to be generated according to the data collection timing. This enables the generation unit to determine the priority of generation based on the data collection timing.

The generation unit can adjust the order of generation based on the relevance of the data when generating the response method. The generation unit can, for example, preferentially generate response methods based on highly relevant data. The generation unit can also postpone the generation of response methods based on less relevant data. The generation unit can also dynamically adjust the order of response methods to be generated according to the relevance of the data. For example, the generation unit preferentially generates response methods based on highly relevant data. The generation unit postpones the generation of response methods based on less relevant data. The generation unit dynamically adjusts the order of response methods to be generated according to the relevance of the data. This enables the generation unit to adjust the order of generation based on the relevance of the data.

The request unit can adjust the level of detail of the request based on the importance of the response method at the time of the request. The request unit can, for example, make detailed requests based on highly important response methods. The request unit can also make simplified requests based on less important response methods. The request unit can also determine the priority of requests according to the importance of the response method. For example, the request unit makes detailed requests based on highly important response methods. The request unit makes simplified requests based on less important response methods. The request unit determines the priority of requests according to the importance of the response method. This enables the request unit to adjust the level of detail of the request based on the importance of the response method.

The request unit can apply different request algorithms according to the category of the response method at the time of the request. The request unit can, for example, apply a specific request algorithm to response methods based on technical specifications. The request unit can also apply a different request algorithm to response methods based on alarm information. The request unit can also apply yet another request algorithm to response methods based on past response histories. For example, the request unit applies a specific request algorithm to response methods based on technical specifications. The request unit applies a different request algorithm to response methods based on alarm information. The request unit applies yet another request algorithm to response methods based on past response histories. This enables the request unit to apply different request algorithms according to the category of the response method.

The request unit can determine the priority of requests based on the generation timing of the response method at the time of the request. The request unit can, for example, preferentially make requests based on the latest response methods. The request unit can also postpone requests based on past response methods. The request unit can also adjust the order of requests according to the generation timing of the response method. For example, the request unit preferentially makes requests based on the latest response methods. The request unit postpones requests based on past response methods. The request unit adjusts the order of requests according to the generation timing of the response method. This enables the request unit to determine the priority of requests based on the generation timing of the response method.

The request unit can adjust the order of requests based on the relevance of the response method at the time of the request. The request unit can, for example, preferentially make requests based on highly relevant response methods. The request unit can also postpone requests based on less relevant response methods. The request unit can also dynamically adjust the order of requests according to the relevance of the response method. For example, the request unit preferentially makes requests based on highly relevant response methods. The request unit postpones requests based on less relevant response methods. The request unit dynamically adjusts the order of requests according to the relevance of the response method. This enables the request unit to adjust the order of requests based on the relevance of the response method.

The system according to the embodiment is not limited to the above-described examples and can be variously modified, for example, as follows.

The maintenance response system can further include a prediction unit. The prediction unit can predict future failure occurrences based on the collected data. For example, the prediction unit analyzes past failure occurrence patterns and predicts the possibility of future failure occurrences. The prediction unit can also use machine learning algorithms to learn data trends and predict future failure occurrences. The prediction unit can also analyze data in real time and detect signs of failure occurrence. This allows the maintenance response system to take preventive measures before a failure occurs and further ensure stable operation of the base station.

The maintenance response system can further include a notification unit. The notification unit can notify stakeholders of the generated response method and predicted failure information. For example, the notification unit notifies stakeholders using email or SMS. The notification unit can also provide real-time notifications through a dedicated application. The notification unit can customize the notification content and provide information according to the roles of stakeholders. This allows stakeholders to quickly grasp response methods and failure information and take appropriate action.

The maintenance response system can further include an evaluation unit. The evaluation unit can evaluate the effectiveness of the generated response method and identify points for improvement. For example, the evaluation unit collects the results after the implementation of the response method and evaluates the effectiveness. The evaluation unit can also quantitatively evaluate the effectiveness of the response method using data analysis techniques. The evaluation unit can also collect feedback from stakeholders and identify points for improvement in the response method. This allows the maintenance response system to continuously improve response methods and enhance the efficiency of base station maintenance operations.

The maintenance response system can further include a learning unit. The learning unit can train the generative AI based on the collected data and evaluation results. For example, the learning unit improves the generative AI algorithm using past response histories and evaluation results. The learning unit can also improve the accuracy of the generative AI using machine learning techniques. The learning unit can also periodically update the data and maintain the latest state of the generative AI. This allows the maintenance response system to always generate optimal response methods and enhance the efficiency of base station maintenance operations.

The maintenance response system can further include a reporting unit. The reporting unit can compile the generated response method and implementation results into a report. For example, the reporting unit automatically compiles the details of the response method and implementation results into a report. The reporting unit can generate the report in PDF or text format and provide it to stakeholders. The reporting unit can customize the content of the report and provide information according to the needs of stakeholders. This allows stakeholders to grasp the response method and implementation results in detail and utilize them for future responses.

The flow of processing in Example 1 of the Embodiment will be briefly described below.

Step 1: The collection unit collects data such as alarm information, technical specifications, and past response histories. For example, the collection unit directly acquires alarm information from sensors in real time and stores it in a database. Technical specifications are collected in PDF or text format and stored in the database. Past response histories are acquired from the database using queries.

Step 2: The analysis unit analyzes the data collected by the collection unit. For example, the analysis unit analyzes the data using generative AI and generates an optimal response method. The analysis unit can also analyze data patterns using data mining techniques and analyze data trends using statistical analysis techniques.

Step 3: The generation unit generates a response method based on the result analyzed by the analysis unit. For example, the generation unit generates a response method using generative AI and can also generate a response method based on manuals and guidelines. The generation unit can also generate a response method with reference to past response histories.

Step 4: The request unit makes a request based on the response method generated by the generation unit. For example, the request unit makes a request to an external contractor and automatically generates a request form to send to the external contractor. The request content can be checked and modified as necessary.

### Example 2 of Embodiment

The maintenance response system according to the embodiment of the present invention is a system that substitutes maintenance response operations for base stations using generative AI. Currently, in the maintenance response system, a person considers a response method based on alarm information, technical specifications, and past response histories, and makes a request to an external contractor, but by replacing these operations with generative AI, the man-hours for base station maintenance operations can be greatly reduced and failure responses that are impossible for humans can be realized. For example, the maintenance response system collects data such as alarm information, technical specifications, and past response histories. Next, the maintenance response system analyzes these data using generative AI and generates an optimal response method. Based on the generated response method, the maintenance response system makes a request to an external contractor. With this mechanism, the efficiency of base station maintenance operations is improved and failure responses that are impossible for humans become possible. For example, when an alarm occurs at a base station, the maintenance response system analyzes the alarm information using generative AI, refers to past response histories and technical specifications, and generates an optimal response method. Based on the generated response method, the maintenance response system makes a request to an external contractor and can respond quickly. With this system, not only can the man-hours for base station maintenance operations be greatly reduced, but also failure responses that are impossible for humans can be realized. For example, even if a complex failure occurs, the maintenance response system can quickly generate an optimal response method using generative AI and respond accordingly. As a result, stable operation of the base station is ensured and service quality can be expected to improve. Thus, the maintenance response system can greatly reduce the man-hours for base station maintenance operations and realize failure responses that are impossible for humans.

The maintenance response system according to the embodiment includes a collection unit, an analysis unit, a generation unit, and a request unit. The collection unit collects data such as alarm information, technical specifications, and past response histories. The collection unit can, for example, collect alarm information in real time. The collection unit can also collect technical specifications in digital format. Furthermore, the collection unit can acquire past response histories from a database. For example, the collection unit directly acquires alarm information from sensors and stores it in a database in real time. Technical specifications are collected in PDF or text format and stored in the database. Past response histories are acquired from the database using queries and provided to the analysis unit. The analysis unit analyzes the data collected by the collection unit. The analysis unit can, for example, analyze the data using generative AI and generate an optimal response method. The analysis unit can also analyze data patterns using data mining techniques. The analysis unit can also analyze data trends using statistical analysis techniques. For example, the analysis unit inputs alarm information, technical specifications, and past response histories into generative AI and generates an optimal response method. Data mining techniques extract useful patterns from the data and help generate response methods. Statistical analysis techniques analyze data trends and improve the accuracy of response methods. The generation unit generates a response method based on the result analyzed by the analysis unit. The generation unit can, for example, generate a response method using generative AI. The generation unit can also generate a response method based on manuals and guidelines. The generation unit can also generate a response method with reference to past response histories. For example, the generation unit inputs the analysis result into generative AI and generates an optimal response method. Manuals and guidelines are referenced in the generation of response methods. Past response histories provide response methods for similar failures. The request unit makes a request based on the response method generated by the generation unit. The request unit can, for example, make a request to an external contractor. The request unit can also automatically generate a request form and send it to the external contractor. The request unit can also check the request content and modify it as necessary. For example, the request unit automatically generates a request form based on the generated response method and sends it to the external contractor. The request form describes the details of the response method and provides specific instructions to the external contractor. The request content is checked by the request unit and modified as necessary. Thus, the maintenance response system according to the embodiment can greatly reduce the man-hours for base station maintenance operations and realize failure responses that are impossible for humans.

The collection unit collects data such as alarm information, technical specifications, and past response histories. Specifically, alarm information is acquired in real time from sensors and immediately stored in a database. This allows the system to always maintain the latest alarm information and enables prompt response. Technical specifications are digitized in PDF or text format and stored in the database. This allows engineers to quickly search for and refer to necessary information. Past response histories are acquired from the database using queries and provided to the analysis unit. This enables analysis based on past response histories and is expected to generate more accurate response methods. The collection unit centrally manages these data and can cooperate with other systems or departments as necessary. For example, the collected data are stored on a cloud server so that the analysis unit and generation unit can access them. In addition, by adjusting the frequency and accuracy of data collection, flexible responses can be made according to specific situations or conditions. This allows the collection unit to efficiently and effectively collect data and improve the overall performance of the system. Furthermore, the collection unit introduces a verification process to ensure the consistency and reliability of the data and maintains data quality. For example, by using algorithms that detect and automatically correct data duplication or missing data, the accuracy of the data can be improved. As a result, the collection unit can provide highly reliable data and improve the reliability of the entire system.

The analysis unit analyzes the data collected by the collection unit. The analysis unit can, for example, analyze the data using generative AI and generate an optimal response method. Specifically, alarm information, technical specifications, and past response histories are input into generative AI to generate an optimal response method. The generative AI uses natural language processing technology to analyze technical specifications and past response histories and proposes response methods based on alarm information. Data mining technology extracts useful patterns from the data and helps generate response methods. For example, common patterns are found from past response histories to identify optimal response methods for similar failures. Statistical analysis technology analyzes data trends and improves the accuracy of response methods. For example, the frequency of alarm information and the content of technical specifications are used to predict the possibility of specific failures and take countermeasures in advance. Furthermore, the analysis unit can utilize past data and statistical information to perform long-term risk assessment and trend analysis. For example, based on past failure data, the analysis unit predicts risk fluctuations in specific regions or time periods and plans future countermeasures. In addition, the analysis unit can use anomaly detection algorithms to detect unusual patterns or abnormal data and issue early warnings. This enables the analysis unit to not only grasp real-time situations but also handle long-term risk management and anomaly detection, thereby improving the reliability and safety of the entire system.

The generation unit generates a response method based on the result analyzed by the analysis unit. The generation unit can, for example, generate a response method using generative AI. Specifically, the analysis result is input into generative AI to generate an optimal response method. The generative AI refers to past response histories and technical specifications to propose optimal response procedures. Manuals and guidelines are referenced in the generation of response methods. For example, standard response procedures for specific failures can be used as a basis to customize specific response methods. Past response histories provide response methods for similar failures. For example, when a similar failure occurred in the past, the response method at that time can be referenced to generate an optimal response procedure. The generation unit integrates this information and can quickly generate an optimal response method. Furthermore, the generation unit can evaluate the accuracy and effectiveness of the generated response method and make corrections as necessary. For example, the generated response method can be simulated to check whether it fits the actual situation. The generation unit can also collect feedback from users and use it to improve response methods. This allows the generation unit to always provide highly accurate response methods based on the latest information and support prompt and appropriate responses. Furthermore, the generation unit can automatically document the generated response method and share it with other departments or systems. This ensures consistency and transparency of response methods and improves the efficiency of the entire system.

The request unit makes a request based on the response method generated by the generation unit. Specifically, a request is made to an external contractor. The request unit can also automatically generate a request form and send it to the external contractor. For example, the request unit automatically generates a request form based on the generated response method and sends it to the external contractor. The request form describes the details of the response method and provides specific instructions to the external contractor. The request content is checked by the request unit and modified as necessary. For example, the content of the request form is checked and corrected if there are errors or unclear points. The request unit can also monitor the progress of the request and follow up as necessary. For example, the request unit receives reports from the external contractor and checks the progress of the response. In addition, the request unit records the request content and progress in a database and uses it as a reference for the future. This allows the request unit to make requests efficiently and effectively and improve the reliability and efficiency of the entire system. Furthermore, the request unit can share the request content and progress with other departments or systems to strengthen overall cooperation. For example, the request unit notifies other departments of the request content and requests necessary support. The request unit can also evaluate the result of the request and use it for future improvement. This allows the request unit to always make optimal responses and improve the performance of the entire system.

The collection unit can collect data such as alarm information, technical specifications, and past response histories. The collection unit can, for example, collect alarm information in real time. The collection unit can also collect technical specifications in digital format. The collection unit can also acquire past response histories from a database. For example, the collection unit directly acquires alarm information from sensors and stores it in a database in real time. Technical specifications are collected in PDF or text format and stored in the database. Past response histories are acquired from the database using queries and provided to the analysis unit. This enables efficient collection of necessary data.

The analysis unit can analyze the collected data and generate an optimal response method. The analysis unit can, for example, analyze the data using generative AI and generate an optimal response method. The analysis unit can also analyze data patterns using data mining techniques. The analysis unit can also analyze data trends using statistical analysis techniques. For example, the analysis unit inputs alarm information, technical specifications, and past response histories into generative AI and generates an optimal response method. Data mining techniques extract useful patterns from the data and help generate response methods. Statistical analysis techniques analyze data trends and improve the accuracy of response methods. This enables the analysis of collected data and the generation of optimal response methods.

The generation unit can make a request to an external contractor based on the generated response method. The generation unit can, for example, generate a response method using generative AI. The generation unit can also generate a response method based on manuals and guidelines. The generation unit can also generate a response method with reference to past response histories. For example, the generation unit inputs the analysis result into generative AI and generates an optimal response method. Manuals and guidelines are referenced in the generation of response methods. Past response histories provide response methods for similar failures. This enables the generation unit to make a request to an external contractor based on the generated response method.

The request unit can make a request based on the generated response method. The request unit can, for example, make a request to an external contractor. The request unit can also automatically generate a request form and send it to the external contractor. The request unit can also check the request content and modify it as necessary. For example, the request unit automatically generates a request form based on the generated response method and sends it to the external contractor. The request form describes the details of the response method and provides specific instructions to the external contractor. The request content is checked by the request unit and modified as necessary. This enables the request unit to make a request based on the generated response method.

The collection unit can estimate a user's emotion and adjust the timing of data collection based on the estimated user's emotion. For example, if the user is feeling stressed, the collection unit reduces the frequency of data collection to reduce the user's burden. If the user is relaxed, the collection unit can increase the frequency of data collection to collect more detailed data. If the user is in a hurry, the collection unit can quickly collect the necessary data by promptly timing the data collection. For example, the collection unit captures the user's facial expressions with a camera and estimates the emotion using an emotion estimation algorithm. The collection unit can also record the user's voice and estimate the emotion using voice analysis technology. The collection unit can also collect the user's biometric data (such as heart rate and skin conductance) with sensors and estimate the emotion using an emotion estimation algorithm. For example, the collection unit calculates an emotion score based on heart rate variability. This allows the timing of data collection to be adjusted according to the user's emotion. Emotion estimation is realized, for example, by using an emotion engine or generative AI as an emotion estimation function. The generative AI may be a text generative AI (e.g., LLM) or a multimodal generative AI, but is not limited to these examples.

The collection unit can analyze past data collection histories and select an optimal collection method. The collection unit can, for example, identify the most efficient collection method from past data collection histories and apply it to future data collection. The collection unit can also select the optimal collection method for specific time periods or conditions based on past data collection histories. The collection unit can analyze past data collection histories, identify points for improvement in collection methods, and optimize them. For example, the collection unit acquires past data collection histories from a database and analyzes them using data mining techniques. The collection unit selects data collection methods for specific time periods or conditions and achieves efficient data collection. The collection unit identifies points for improvement in collection methods and optimizes them to improve the accuracy and efficiency of data collection. This enables the collection unit to analyze past data collection histories and select an optimal collection method.

The collection unit can perform filtering based on the current operational status and environmental conditions of a base station during data collection. The collection unit can, for example, monitor the operational status of the base station in real time and collect data only when an abnormality occurs. The collection unit can also prioritize data collection under specific conditions by considering environmental conditions (such as weather and temperature). The collection unit can also adjust the type and amount of data to be collected based on the operational status and environmental conditions of the base station. For example, the collection unit monitors the operational status of the base station in real time and collects data only when an abnormality occurs. The collection unit prioritizes data collection under specific conditions by considering environmental conditions (such as weather and temperature). The collection unit adjusts the type and amount of data to be collected based on the operational status and environmental conditions of the base station. This enables the collection unit to filter data collection based on the operational status and environmental conditions of the base station.

The collection unit can estimate a user's emotion and determine the priority of data to be collected based on the estimated user's emotion. For example, if the user is feeling stressed, the collection unit prioritizes the collection of highly important data. If the user is relaxed, the collection unit can prioritize the collection of detailed data. If the user is in a hurry, the collection unit can prioritize the collection of data that can be collected quickly. For example, the collection unit captures the user's facial expressions with a camera and estimates the emotion using an emotion estimation algorithm. The collection unit can also record the user's voice and estimate the emotion using voice analysis technology. The collection unit can also collect the user's biometric data (such as heart rate and skin conductance) with sensors and estimate the emotion using an emotion estimation algorithm. For example, the collection unit calculates an emotion score based on heart rate variability. This allows the priority of data to be collected to be determined according to the user's emotion. Emotion estimation is realized, for example, by using an emotion engine or generative AI as an emotion estimation function. The generative AI may be a text generative AI (e.g., LLM) or a multimodal generative AI, but is not limited to these examples.

The collection unit can preferentially collect highly relevant data by considering the geographical location information of the base station during data collection. The collection unit can, for example, preferentially collect environmental data in the vicinity based on the geographical location information of the base station. The collection unit can also prioritize data collection in specific regions by considering the geographical location information of the base station. The collection unit can also filter and collect highly relevant data based on the geographical location information of the base station. For example, the collection unit preferentially collects environmental data in the vicinity based on the geographical location information of the base station. The collection unit prioritizes data collection in specific regions by considering the geographical location information of the base station. The collection unit filters and collects highly relevant data based on the geographical location information of the base station. This enables the collection unit to preferentially collect highly relevant data by considering the geographical location information of the base station.

The collection unit can analyze the social media activities of the base station during data collection and collect relevant data. The collection unit can, for example, monitor the social media activities of the base station and collect relevant data. The collection unit can also analyze trends on social media and preferentially collect data related to the base station. The collection unit can also collect data related to the base station based on user feedback on social media. For example, the collection unit monitors the social media activities of the base station and collects relevant data. The collection unit analyzes trends on social media and preferentially collects data related to the base station. The collection unit collects data related to the base station based on user feedback on social media. This enables the collection unit to analyze the social media activities of the base station and collect relevant data.

The analysis unit can estimate a user's emotion and adjust the expression method of analysis based on the estimated user's emotion. For example, if the user is nervous, the analysis unit provides a simple and highly visible analysis result. If the user is relaxed, the analysis unit can provide a detailed analysis result. If the user is in a hurry, the analysis unit can provide an analysis result that focuses on the main points. For example, the analysis unit captures the user's facial expressions with a camera and estimates the emotion using an emotion estimation algorithm. The analysis unit can also record the user's voice and estimate the emotion using voice analysis technology. The analysis unit can also collect the user's biometric data (such as heart rate and skin conductance) with sensors and estimate the emotion using an emotion estimation algorithm. For example, the analysis unit calculates an emotion score based on heart rate variability. This allows the expression method of analysis to be adjusted according to the user's emotion. Emotion estimation is realized, for example, by using an emotion engine or generative AI as an emotion estimation function. The generative AI may be a text generative AI (e.g., LLM) or a multimodal generative AI, but is not limited to these examples.

The analysis unit can adjust the level of detail of analysis based on the importance of the data during analysis. The analysis unit can, for example, perform detailed analysis for highly important data. The analysis unit can also perform simplified analysis for less important data. The analysis unit can also determine the priority of analysis according to the importance of the data. For example, the analysis unit evaluates the importance of the data and performs detailed analysis for highly important data. The analysis unit performs simplified analysis for less important data. The analysis unit determines the priority of analysis according to the importance of the data. This enables the analysis unit to adjust the level of detail of analysis based on the importance of the data.

The analysis unit can apply different analysis algorithms according to the category of data during analysis. The analysis unit can, for example, apply a specific analysis algorithm to data based on technical specifications. The analysis unit can also apply a different analysis algorithm to data based on alarm information. The analysis unit can also apply yet another analysis algorithm to data based on past response histories. For example, the analysis unit applies a specific analysis algorithm to data based on technical specifications. The analysis unit applies a different analysis algorithm to data based on alarm information. The analysis unit applies yet another analysis algorithm to data based on past response histories. This enables the analysis unit to apply different analysis algorithms according to the category of data.

The analysis unit can estimate a user's emotion and adjust the length of analysis based on the estimated user's emotion. For example, if the user is in a hurry, the analysis unit performs a short and concise analysis. If the user is relaxed, the analysis unit can perform a detailed analysis. If the user is excited, the analysis unit can perform a visually stimulating analysis. For example, the analysis unit captures the user's facial expressions with a camera and estimates the emotion using an emotion estimation algorithm. The analysis unit can also record the user's voice and estimate the emotion using voice analysis technology. The analysis unit can also collect the user's biometric data (such as heart rate and skin conductance) with sensors and estimate the emotion using an emotion estimation algorithm. For example, the analysis unit calculates an emotion score based on heart rate variability. This allows the length of analysis to be adjusted according to the user's emotion. Emotion estimation is realized, for example, by using an emotion engine or generative AI as an emotion estimation function. The generative AI may be a text generative AI (e.g., LLM) or a multimodal generative AI, but is not limited to these examples.

The analysis unit can determine the priority of analysis based on the data collection timing during analysis. The analysis unit can, for example, preferentially analyze the latest data. The analysis unit can also preferentially analyze data from specific periods based on past data. The analysis unit can also adjust the order of analysis according to the data collection timing. For example, the analysis unit preferentially analyzes the latest data. The analysis unit preferentially analyzes data from specific periods based on past data. The analysis unit adjusts the order of analysis according to the data collection timing. This enables the analysis unit to determine the priority of analysis based on the data collection timing.

The analysis unit can adjust the order of analysis based on the relevance of the data during analysis. The analysis unit can, for example, preferentially analyze highly relevant data. The analysis unit can also postpone the analysis of less relevant data. The analysis unit can also dynamically adjust the order of analysis according to the relevance of the data. For example, the analysis unit preferentially analyzes highly relevant data. The analysis unit postpones the analysis of less relevant data. The analysis unit dynamically adjusts the order of analysis according to the relevance of the data. This enables the analysis unit to adjust the order of analysis based on the relevance of the data.

The generation unit can estimate a user's emotion and adjust the expression method of the response method to be generated based on the estimated user's emotion. For example, if the user is nervous, the generation unit generates a simple and highly visible response method. If the user is relaxed, the generation unit can generate a detailed response method. If the user is in a hurry, the generation unit can generate a response method that focuses on the main points. For example, the generation unit captures the user's facial expressions with a camera and estimates the emotion using an emotion estimation algorithm. The generation unit can also record the user's voice and estimate the emotion using voice analysis technology. The generation unit can also collect the user's biometric data (such as heart rate and skin conductance) with sensors and estimate the emotion using an emotion estimation algorithm. For example, the generation unit calculates an emotion score based on heart rate variability. This allows the expression method of the response method to be generated to be adjusted according to the user's emotion. Emotion estimation is realized, for example, by using an emotion engine or generative AI as an emotion estimation function. The generative AI may be a text generative AI (e.g., LLM) or a multimodal generative AI, but is not limited to these examples.

The generation unit can adjust the level of detail of generation based on the importance of the data when generating the response method. The generation unit can, for example, generate response methods based on highly important data in detail. The generation unit can also generate response methods based on less important data in a simplified manner. The generation unit can also determine the priority of response methods to be generated according to the importance of the data. For example, the generation unit generates response methods based on highly important data in detail. The generation unit generates response methods based on less important data in a simplified manner. The generation unit determines the priority of response methods to be generated according to the importance of the data. This enables the generation unit to adjust the level of detail of generation based on the importance of the data.

The generation unit can apply different generation algorithms according to the category of data when generating the response method. The generation unit can, for example, apply a specific generation algorithm to response methods based on technical specifications. The generation unit can also apply a different generation algorithm to response methods based on alarm information. The generation unit can also apply yet another generation algorithm to response methods based on past response histories. For example, the generation unit applies a specific generation algorithm to response methods based on technical specifications. The generation unit applies a different generation algorithm to response methods based on alarm information. The generation unit applies yet another generation algorithm to response methods based on past response histories. This enables the generation unit to apply different generation algorithms according to the category of data.

The generation unit can estimate a user's emotion and determine the priority of the response method to be generated based on the estimated user's emotion. For example, if the user is nervous, the generation unit preferentially generates highly important response methods. If the user is relaxed, the generation unit can preferentially generate detailed response methods. If the user is in a hurry, the generation unit can preferentially generate response methods that can be generated quickly. For example, the generation unit captures the user's facial expressions with a camera and estimates the emotion using an emotion estimation algorithm. The generation unit can also record the user's voice and estimate the emotion using voice analysis technology. The generation unit can also collect the user's biometric data (such as heart rate and skin conductance) with sensors and estimate the emotion using an emotion estimation algorithm. For example, the generation unit calculates an emotion score based on heart rate variability. This allows the priority of the response method to be generated to be determined according to the user's emotion. Emotion estimation is realized, for example, by using an emotion engine or generative AI as an emotion estimation function. The generative AI may be a text generative AI (e.g., LLM) or a multimodal generative AI, but is not limited to these examples.

The generation unit can determine the priority of generation based on the data collection timing when generating the response method. The generation unit can, for example, preferentially generate response methods based on the latest data. The generation unit can also postpone the generation of response methods based on past data. The generation unit can also adjust the order of response methods to be generated according to the data collection timing. For example, the generation unit preferentially generates response methods based on the latest data. The generation unit postpones the generation of response methods based on past data. The generation unit adjusts the order of response methods to be generated according to the data collection timing. This enables the generation unit to determine the priority of generation based on the data collection timing.

The generation unit can adjust the order of generation based on the relevance of the data when generating the response method. The generation unit can, for example, preferentially generate response methods based on highly relevant data. The generation unit can also postpone the generation of response methods based on less relevant data. The generation unit can also dynamically adjust the order of response methods to be generated according to the relevance of the data. For example, the generation unit preferentially generates response methods based on highly relevant data. The generation unit postpones the generation of response methods based on less relevant data. The generation unit dynamically adjusts the order of response methods to be generated according to the relevance of the data. This enables the generation unit to adjust the order of generation based on the relevance of the data.

The request unit can estimate a user's emotion and adjust the expression method of the request based on the estimated user's emotion. For example, if the user is nervous, the request unit provides a simple and highly visible request method. If the user is relaxed, the request unit can provide a detailed request method. If the user is in a hurry, the request unit can provide a request method that focuses on the main points. For example, the request unit captures the user's facial expressions with a camera and estimates the emotion using an emotion estimation algorithm. The request unit can also record the user's voice and estimate the emotion using voice analysis technology. The request unit can also collect the user's biometric data (such as heart rate and skin conductance) with sensors and estimate the emotion using an emotion estimation algorithm. For example, the request unit calculates an emotion score based on heart rate variability. This allows the expression method of the request to be adjusted according to the user's emotion. Emotion estimation is realized, for example, by using an emotion engine or generative AI as an emotion estimation function. The generative AI may be a text generative AI (e.g., LLM) or a multimodal generative AI, but is not limited to these examples.

The request unit can adjust the level of detail of the request based on the importance of the response method at the time of the request. The request unit can, for example, make detailed requests based on highly important response methods. The request unit can also make simplified requests based on less important response methods. The request unit can also determine the priority of requests according to the importance of the response method. For example, the request unit makes detailed requests based on highly important response methods. The request unit makes simplified requests based on less important response methods. The request unit determines the priority of requests according to the importance of the response method. This enables the request unit to adjust the level of detail of the request based on the importance of the response method.

The request unit can apply different request algorithms according to the category of the response method at the time of the request. The request unit can, for example, apply a specific request algorithm to response methods based on technical specifications. The request unit can also apply a different request algorithm to response methods based on alarm information. The request unit can also apply yet another request algorithm to response methods based on past response histories. For example, the request unit applies a specific request algorithm to response methods based on technical specifications. The request unit applies a different request algorithm to response methods based on alarm information. The request unit applies yet another request algorithm to response methods based on past response histories. This enables the request unit to apply different request algorithms according to the category of the response method.

The request unit can estimate a user's emotion and determine the priority of the request based on the estimated user's emotion. For example, if the user is nervous, the request unit preferentially makes highly important requests. If the user is relaxed, the request unit can preferentially make detailed requests. If the user is in a hurry, the request unit can preferentially make requests that can be made quickly. For example, the request unit captures the user's facial expressions with a camera and estimates the emotion using an emotion estimation algorithm. The request unit can also record the user's voice and estimate the emotion using voice analysis technology. The request unit can also collect the user's biometric data (such as heart rate and skin conductance) with sensors and estimate the emotion using an emotion estimation algorithm. For example, the request unit calculates an emotion score based on heart rate variability. This allows the priority of the request to be determined according to the user's emotion. Emotion estimation is realized, for example, by using an emotion engine or generative AI as an emotion estimation function. The generative AI may be a text generative AI (e.g., LLM) or a multimodal generative AI, but is not limited to these examples.

The request unit can determine the priority of requests based on the generation timing of the response method at the time of the request. The request unit can, for example, preferentially make requests based on the latest response methods. The request unit can also postpone requests based on past response methods. The request unit can also adjust the order of requests according to the generation timing of the response method. For example, the request unit preferentially makes requests based on the latest response methods. The request unit postpones requests based on past response methods. The request unit adjusts the order of requests according to the generation timing of the response method. This enables the request unit to determine the priority of requests based on the generation timing of the response method.

The request unit can adjust the order of requests based on the relevance of the response method at the time of the request. The request unit can, for example, preferentially make requests based on highly relevant response methods. The request unit can also postpone requests based on less relevant response methods. The request unit can also dynamically adjust the order of requests according to the relevance of the response method. For example, the request unit preferentially makes requests based on highly relevant response methods. The request unit postpones requests based on less relevant response methods. The request unit dynamically adjusts the order of requests according to the relevance of the response method. This enables the request unit to adjust the order of requests based on the relevance of the response method.

The system according to the embodiment is not limited to the above-described examples and can be variously modified, for example, as follows.

The maintenance response system can further include a prediction unit. The prediction unit can predict future failure occurrences based on the collected data. For example, the prediction unit analyzes past failure occurrence patterns and predicts the possibility of future failure occurrences. The prediction unit can also use machine learning algorithms to learn data trends and predict future failure occurrences. The prediction unit can also analyze data in real time and detect signs of failure occurrence. This allows the maintenance response system to take preventive measures before a failure occurs and further ensure stable operation of the base station.

The maintenance response system can further include a notification unit. The notification unit can notify stakeholders of the generated response method and predicted failure information. For example, the notification unit notifies stakeholders using email or SMS. The notification unit can also provide real-time notifications through a dedicated application. The notification unit can customize the notification content and provide information according to the roles of stakeholders. This allows stakeholders to quickly grasp response methods and failure information and take appropriate action.

The maintenance response system can further include an evaluation unit. The evaluation unit can evaluate the effectiveness of the generated response method and identify points for improvement. For example, the evaluation unit collects the results after the implementation of the response method and evaluates the effectiveness. The evaluation unit can also quantitatively evaluate the effectiveness of the response method using data analysis techniques. The evaluation unit can also collect feedback from stakeholders and identify points for improvement in the response method. This allows the maintenance response system to continuously improve response methods and enhance the efficiency of base station maintenance operations.

The maintenance response system can further include a learning unit. The learning unit can train the generative AI based on the collected data and evaluation results. For example, the learning unit improves the generative AI algorithm using past response histories and evaluation results. The learning unit can also improve the accuracy of the generative AI using machine learning techniques. The learning unit can also periodically update the data and maintain the latest state of the generative AI. This allows the maintenance response system to always generate optimal response methods and enhance the efficiency of base station maintenance operations.

The maintenance response system can further include a reporting unit. The reporting unit can compile the generated response method and implementation results into a report. For example, the reporting unit automatically compiles the details of the response method and implementation results into a report. The reporting unit can generate the report in PDF or text format and provide it to stakeholders. The reporting unit can customize the content of the report and provide information according to the needs of stakeholders. This allows stakeholders to grasp the response method and implementation results in detail and utilize them for future responses.

The maintenance response system can estimate a user's emotion and adjust the notification content based on the estimated user's emotion. For example, if the user is feeling stressed, the notification content is made concise and only important information is provided. If the user is relaxed, the notification content can be detailed. If the user is in a hurry, information that requires prompt action can be preferentially notified. This allows the notification content to be adjusted according to the user's emotion and appropriate information to be provided.

The maintenance response system can estimate a user's emotion and adjust the expression method of evaluation results based on the estimated user's emotion. For example, if the user is nervous, the system provides a simple and highly visible evaluation result. If the user is relaxed, the system can provide a detailed evaluation result. If the user is in a hurry, the system can provide an evaluation result that focuses on the main points. This allows the expression method of evaluation results to be adjusted according to the user's emotion and appropriate information to be provided.

The maintenance response system can estimate a user's emotion and select learning data based on the estimated user's emotion. For example, if the user is feeling stressed, the amount of learning data is reduced to lessen the burden. If the user is relaxed, the system can select detailed learning data. If the user is in a hurry, the system can select data that can be learned quickly. This allows the selection of learning data according to the user's emotion and enables efficient learning.

The maintenance response system can estimate a user's emotion and adjust the content of the report based on the estimated user's emotion. For example, if the user is nervous, the system provides a simple and highly visible report. If the user is relaxed, the system can provide a detailed report. If the user is in a hurry, the system can provide a report that focuses on the main points. This allows the content of the report to be adjusted according to the user's emotion and appropriate information to be provided.

The maintenance response system can estimate a user's emotion and adjust the expression method of prediction results based on the estimated user's emotion. For example, if the user is nervous, the system provides a simple and highly visible prediction result. If the user is relaxed, the system can provide a detailed prediction result. If the user is in a hurry, the system can provide a prediction result that focuses on the main points. This allows the expression method of prediction results to be adjusted according to the user's emotion and appropriate information to be provided.

The flow of processing in Example 2 of the Embodiment will be briefly described below.

Step 1: The collection unit collects data such as alarm information, technical specifications, and past response histories. For example, the collection unit directly acquires alarm information from sensors in real time and stores it in a database. Technical specifications are collected in PDF or text format and stored in the database. Past response histories are acquired from the database using queries.

Step 2: The analysis unit analyzes the data collected by the collection unit. For example, the analysis unit analyzes the data using generative AI and generates an optimal response method. The analysis unit can also analyze data patterns using data mining techniques and analyze data trends using statistical analysis techniques.

Step 3: The generation unit generates a response method based on the result analyzed by the analysis unit. For example, the generation unit generates a response method using generative AI and can also generate a response method based on manuals and guidelines. The generation unit can also generate a response method with reference to past response histories.

Step 4: The request unit makes a request based on the response method generated by the generation unit. For example, the request unit makes a request to an external contractor and automatically generates a request form to send to the external contractor. The request content can be checked and modified as necessary.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described collection unit, analysis unit, generation unit, and request unit is implemented by at least one of, for example, the smart device 14 and the data processing apparatus 12. For example, the collection unit collects alarm information in real time using the camera 42 or sensors of the smart device 14, and acquires technical specifications and past response histories from the database 24 by the specific processing unit 290 of the data processing apparatus 12. The analysis unit, for example, analyzes the data using generative AI by the specific processing unit 290 of the data processing apparatus 12 and generates an optimal response method. The generation unit, for example, generates a response method based on the analysis result by the specific processing unit 290 of the data processing apparatus 12. The request unit, for example, makes a request to an external contractor based on the response method generated by the control unit 46A of the smart device 14. The correspondence between each unit and the device or control unit is not limited to the above examples and can be variously modified.

### Second Embodiment

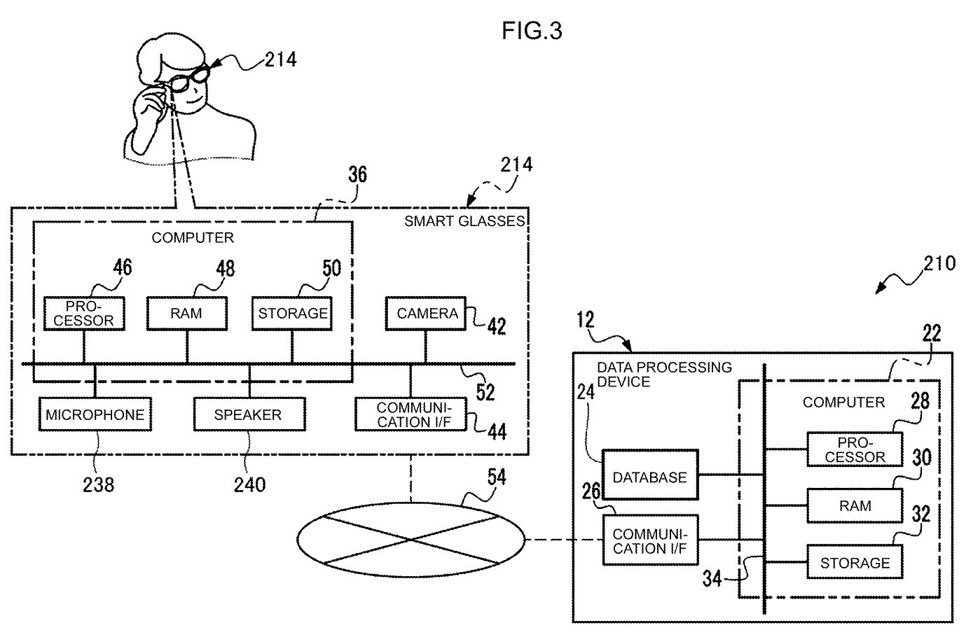

FIG. 3 shows an example configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 includes a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

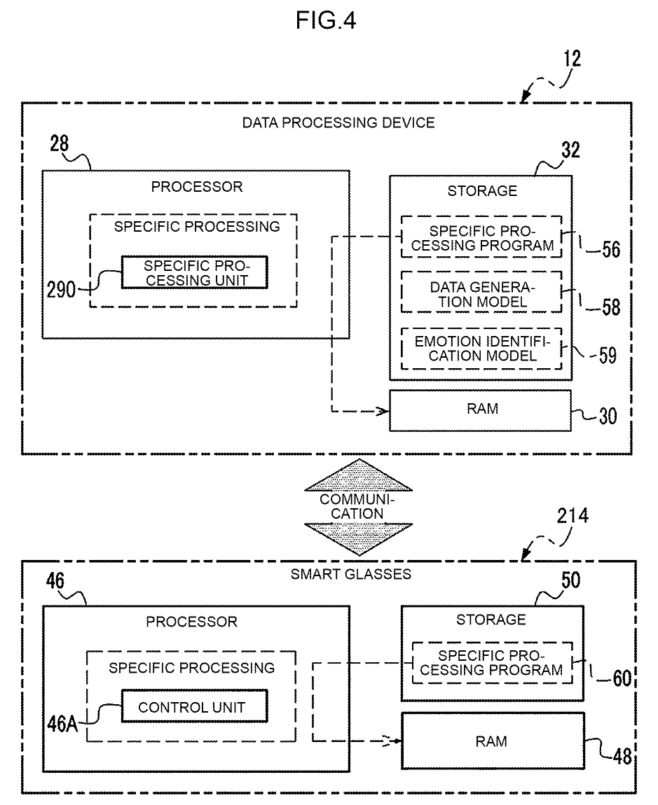

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described collection unit, analysis unit, generation unit, and request unit is implemented by at least one of, for example, the smart glasses 214 and the data processing apparatus 12. For example, the collection unit collects alarm information in real time using the camera 42 or sensors of the smart glasses 214, and acquires technical specifications and past response histories from the database 24 by the specific processing unit 290 of the data processing apparatus 12. The analysis unit, for example, analyzes the data using generative AI by the specific processing unit 290 of the data processing apparatus 12 and generates an optimal response method. The generation unit, for example, generates a response method based on the analysis result by the specific processing unit 290 of the data processing apparatus 12. The request unit, for example, makes a request to an external contractor based on the response method generated by the control unit 46A of the smart glasses 214. The correspondence between each unit and the device or control unit is not limited to the above examples and can be variously modified.

### Third Embodiment

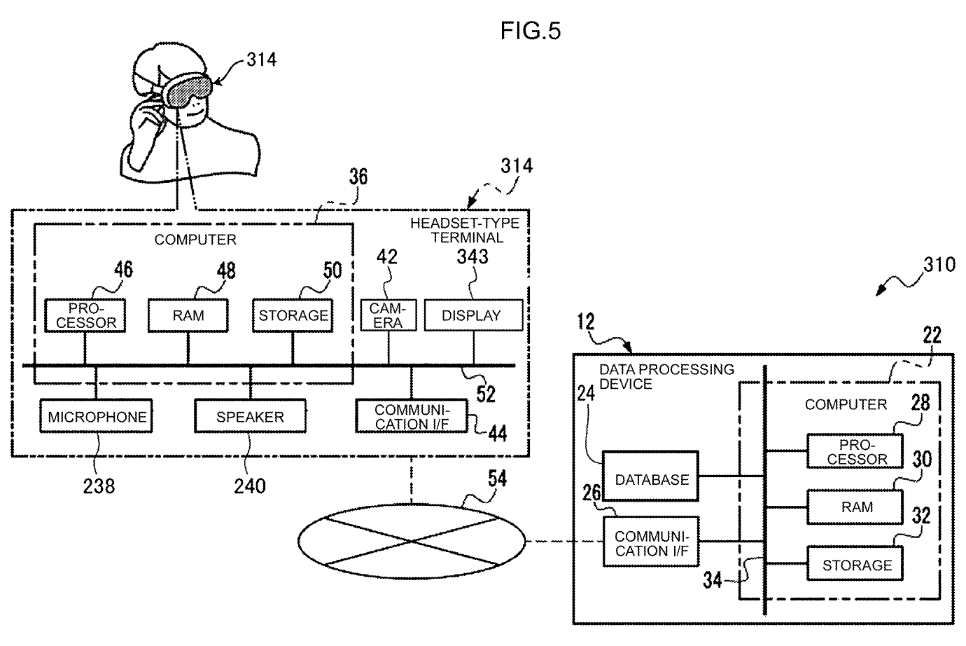

FIG. 5 shows an example configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

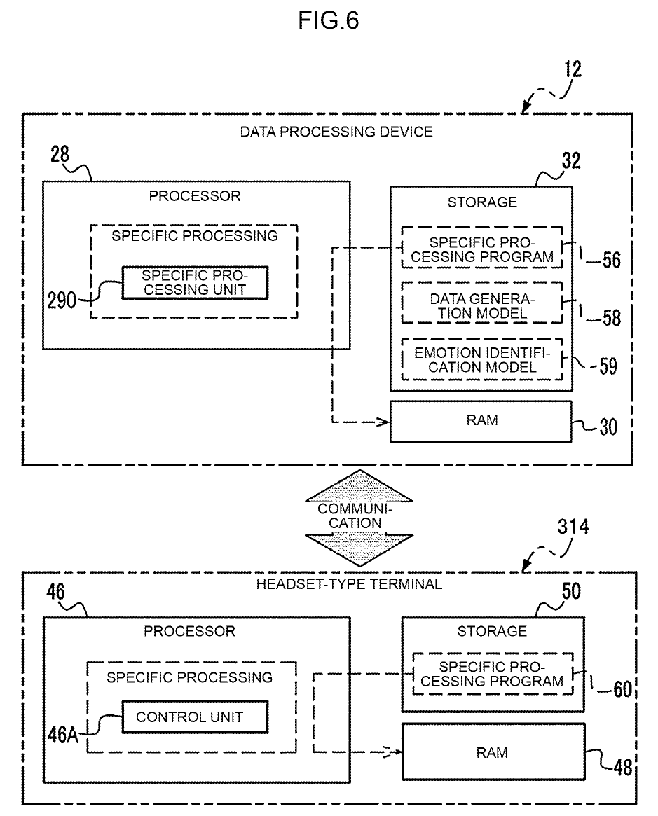

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described collection unit, analysis unit, generation unit, and request unit is implemented by at least one of, for example, the headset-type terminal 314 and the data processing apparatus 12. For example, the collection unit collects alarm information in real time using the camera 42 or sensors of the headset-type terminal 314, and acquires technical specifications and past response histories from the database 24 by the specific processing unit 290 of the data processing apparatus 12. The analysis unit, for example, analyzes the data using generative AI by the specific processing unit 290 of the data processing apparatus 12 and generates an optimal response method. The generation unit, for example, generates a response method based on the analysis result by the specific processing unit 290 of the data processing apparatus 12. The request unit, for example, makes a request to an external contractor based on the response method generated by the control unit 46A of the headset-type terminal 314. The correspondence between each unit and the device or control unit is not limited to the above examples and can be variously modified.

### Fourth Embodiment

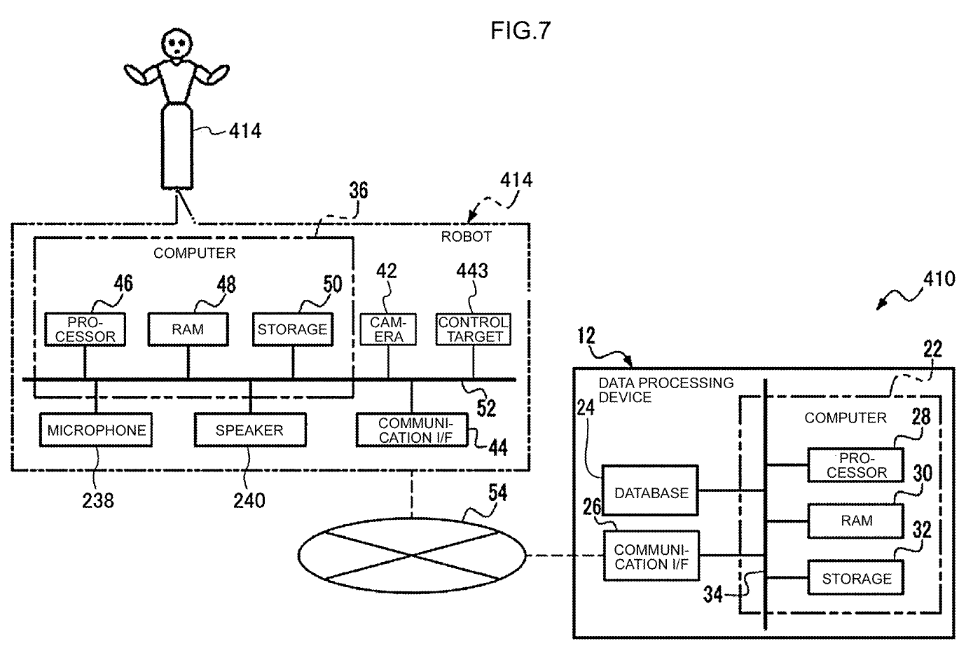

FIG. 7 shows an example configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

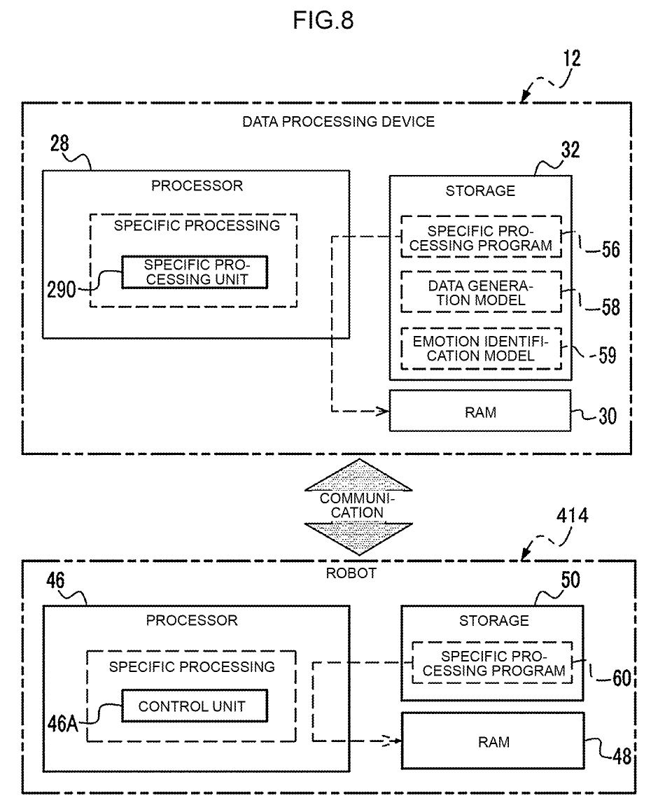

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described collection unit, analysis unit, generation unit, and request unit is implemented by at least one of, for example, the robot 414 and the data processing apparatus 12. For example, the collection unit collects alarm information in real time using the camera 42 or sensors of the robot 414, and acquires technical specifications and past response histories from the database 24 by the specific processing unit 290 of the data processing apparatus 12. The analysis unit, for example, analyzes the data using generative AI by the specific processing unit 290 of the data processing apparatus 12 and generates an optimal response method. The generation unit, for example, generates a response method based on the analysis result by the specific processing unit 290 of the data processing apparatus 12. The request unit, for example, makes a request to an external contractor based on the response method generated by the control unit 46A of the robot 414. The correspondence between each unit and the device or control unit is not limited to the above examples and can be variously modified.

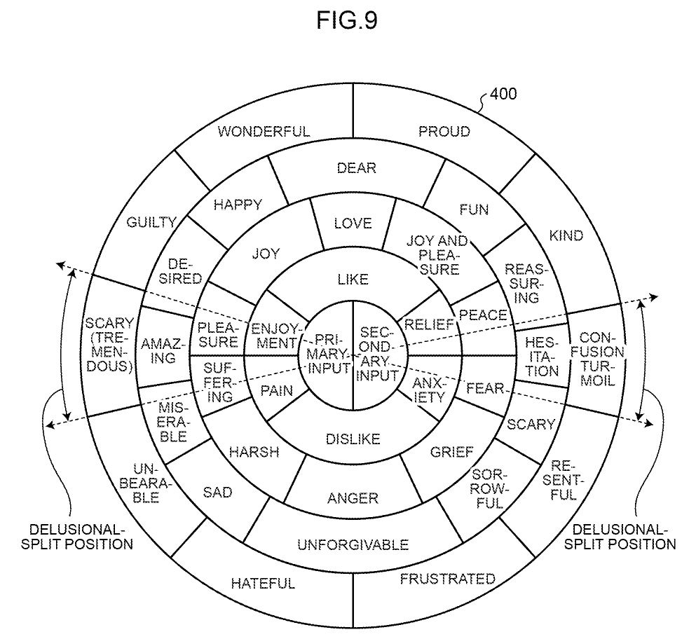

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, "pleasant" emotions are arranged, and on the lower side, "unpleasant" emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called "reactions," where sensations take precedence, are aligned. Additionally, in the right half of the emotion map, emotions belonging to the domain called "situations," where situational recognition takes precedence, are aligned.

In the emotion map, two emotions that promote learning are defined. One is a negative emotion around "repentance" or "reflection" on the situation side. In other words, when a negative emotion arises in the robot, like "I never want to feel this way again" or "I don't want to be scolded again." The other is an emotion around "desire" on the reaction side, which is positive. In other words, it is a positive feeling like "I want more" or "I want to know more."

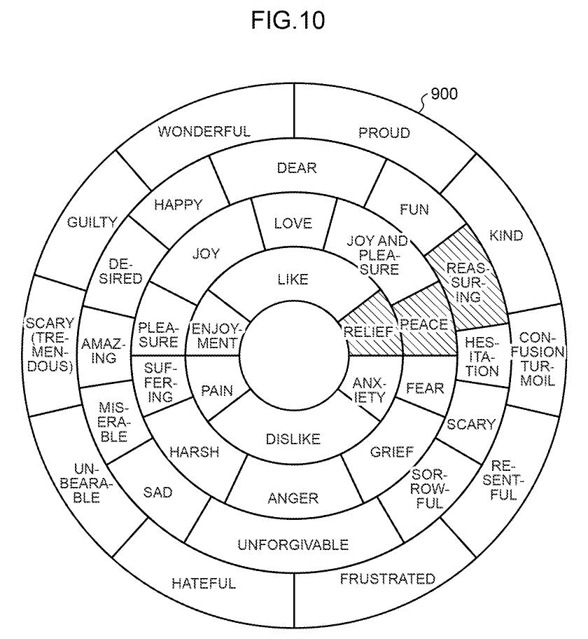

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like "reassured," "calm," and "confident" have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

[Additional Note 1] A system including: a collection unit configured to collect data such as alarm information, technical specifications, and past response histories; an analysis unit configured to analyze the data collected by the collection unit; a generation unit configured to generate a response method based on the result analyzed by the analysis unit; and a request unit configured to make a request based on the response method generated by the generation unit.

[Additional Note 2] The system according to Additional Note 1, wherein the collection unit is configured to collect data such as alarm information, technical specifications, and past response histories.

[Additional Note 3] The system according to Additional Note 1, wherein the analysis unit is configured to analyze the collected data and generate an optimal response method.

[Additional Note 4] The system according to Additional Note 1, wherein the generation unit is configured to make a request to an external contractor based on the generated response method.

[Additional Note 5] The system according to Additional Note 1, wherein the request unit is configured to make a request based on the generated response method.

[Additional Note 6] The system according to Additional Note 1, wherein the collection unit is configured to estimate a user's emotion and adjust the timing of data collection based on the estimated user's emotion.

[Additional Note 7] The system according to Additional Note 1, wherein the collection unit is configured to analyze past data collection histories and select an optimal collection method.

[Additional Note 8] The system according to Additional Note 1, wherein the collection unit is configured to perform filtering based on the current operational status and environmental conditions of a base station during data collection.

[Additional Note 9] The system according to Additional Note 1, wherein the collection unit is configured to estimate a user's emotion and determine the priority of data to be collected based on the estimated user's emotion.

[Additional Note 10] The system according to Additional Note 1, wherein the collection unit is configured to preferentially collect highly relevant data by considering the geographical location information of the base station during data collection.

[Additional Note 11] The system according to Additional Note 1, wherein the collection unit is configured to analyze the social media activities of the base station during data collection and collect relevant data.

[Additional Note 12] The system according to Additional Note 1, wherein the analysis unit is configured to estimate a user's emotion and adjust the expression method of analysis based on the estimated user's emotion.

[Additional Note 13] The system according to Additional Note 1, wherein the analysis unit is configured to adjust the level of detail of analysis based on the importance of the data during analysis.

[Additional Note 14] The system according to Additional Note 1, wherein the analysis unit is configured to apply different analysis algorithms according to the category of data during analysis.

[Additional Note 15] The system according to Additional Note 1, wherein the analysis unit is configured to estimate a user's emotion and adjust the length of analysis based on the estimated user's emotion.

[Additional Note 16] The system according to Additional Note 1, wherein the analysis unit is configured to determine the priority of analysis based on the data collection timing during analysis.

[Additional Note 17] The system according to Additional Note 1, wherein the analysis unit is configured to adjust the order of analysis based on the relevance of the data during analysis.

[Additional Note 18] The system according to Additional Note 1, wherein the generation unit is configured to estimate a user's emotion and adjust the expression method of the response method to be generated based on the estimated user's emotion.

[Additional Note 19] The system according to Additional Note 1, wherein the generation unit is configured to adjust the level of detail of generation based on the importance of the data when generating the response method.

[Additional Note 20] The system according to Additional Note 1, wherein the generation unit is configured to apply different generation algorithms according to the category of data when generating the response method.

[Additional Note 21] The system according to Additional Note 1, wherein the generation unit is configured to estimate a user's emotion and determine the priority of the response method to be generated based on the estimated user's emotion.

[Additional Note 22] The system according to Additional Note 1, wherein the generation unit is configured to determine the priority of generation based on the data collection timing when generating the response method.

[Additional Note 23] The system according to Additional Note 1, wherein the generation unit is configured to adjust the order of generation based on the relevance of the data when generating the response method.

[Additional Note 24] The system according to Additional Note 1, wherein the request unit is configured to estimate a user's emotion and adjust the expression method of the request based on the estimated user's emotion.

[Additional Note 25] The system according to Additional Note 1, wherein the request unit is configured to adjust the level of detail of the request based on the importance of the response method at the time of the request.

[Additional Note 26] The system according to Additional Note 1, wherein the request unit is configured to apply different request algorithms according to the category of the response method at the time of the request.

[Additional Note 27] The system according to Additional Note 1, wherein the request unit is configured to estimate a user's emotion and determine the priority of the request based on the estimated user's emotion.

[Additional Note 28] The system according to Additional Note 1, wherein the request unit is configured to determine the priority of the request based on the generation timing of the response method at the time of the request.

[Additional Note 29] The system according to Additional Note 1, wherein the request unit is configured to adjust the order of the request based on the relevance of the response method at the time of the request.

What is claimed is:

1. A system comprising: a collection unit configured to collect data such as alarm information, technical specifications, and past response histories; an analysis unit configured to analyze the data collected by the collection unit; a generation unit configured to generate a response method based on the result analyzed by the analysis unit; and a request unit configured to make a request based on the response method generated by the generation unit.

2. The system according to claim 1, wherein the collection unit is configured to collect data such as alarm information, technical specifications, and past response histories.

3. The system according to claim 1, wherein the analysis unit is configured to analyze the collected data and generate an optimal response method.

4. The system according to claim 1, wherein the generation unit is configured to make a request to an external contractor based on the generated response method.

5. The system according to claim 1, wherein the request unit is configured to make a request based on the generated response method.

6. The system according to claim 1, wherein the collection unit is configured to estimate a user's emotion and adjust the timing of data collection based on the estimated user's emotion.

7. The system according to claim 1, wherein the collection unit is configured to analyze past data collection histories and select an optimal collection method.

8. The system according to claim 1, wherein the collection unit is configured to perform filtering based on the current operational status and environmental conditions of a base station during data collection.
